(19) United States
(12) Patent Application Publication
(10) Pub. No.: US 2025/0135506 A1
(43) Pub. Date: May 1, 2025

(54) STRUCTURE THAT APPLIES TO A STEAM CLEANER AND CONTROLS THE AMOUNT OF STEAM BY PWM

(71) Applicant: SHENZHEN HUIKAIDA TECHNOLOGY CO., LTD, Shenzhen (CN)

(72) Inventor: He ZHANG, Guangzhou (CN)

(21) Appl. No.: 19/004,925

(22) Filed: Dec. 30, 2024

(30) Foreign Application Priority Data
Dec. 11, 2024 (CN) 202423047031.0

(51) Int. Cl. B08B 3/00; B08B 13/00

(52) U.S. Cl. CPC B08B 3/00; B08B 13/00; B08B 2220/00; B08B 2230/01

(57) ABSTRACT

This invention provides a structure for applying on a steam cleaner to control the amount of steam through PWM, including: a casing, one side of which is fixedly installed with a power line, the output end of which is electrically connected to a power switch, the output end of which is electrically connected to a control board, and the output end of which is electrically connected to a pump, steam generator, and display screen; a water tank, which is fixedly installed at the bottom of the inner side of the casing.

### TECHNICAL FIELD

The present invention relates to the field of steam cleaning technology, and particularly relates to a structure for applying to a steam cleaning machine and controlling the amount of steam by PWM.

### BACKGROUND TECHNOLOGY

The steam cleaner is a cleaning device that utilizes the high temperature of saturated steam and external high pressure to clean oil stains and contaminants from the surface of parts, vaporizing and evaporating them. It can also clean any tiny gaps and holes, stripping and removing oil stains and residues, achieving the requirements of high efficiency, water saving, cleanliness, drying, and low cost, replacing expensive dry ice cleaning.

Like a patent application for a structure applied to a steam cleaner that controls steam volume through PWM control, it has an operating panel fixedly installed in the middle of the box body cavity, a heater fixedly installed on the left side of the bottom of the operating panel, a circuit board in the middle of the operating panel, and a power adapter fixedly installed at the bottom of the circuit board. This invention adopts a waterproof design, uses an operating panel installed with downward folding edges, and fixes the heater, circuit board, power adapter, and water pump all at the bottom of the operating panel. The operating panel is made of waterproof material, so when water splashes onto the surface of the operating panel, it will flow down along the folding edge and directly into the box body cavity without seeping into the electrical components inside the box. After the water flows to the bottom of the box, there is a drainage hole at the bottom of the box, which provides good protection for the components installed under the panel and facilitates maintenance and replacement, saving materials while addressing the drawback of the existing structure for steam cleaners that controls steam volume through PWM control not being waterproof on the machine itself and its surroundings.

However, the structure of the application in the steam cleaning machine, which controls the amount of steam by PWM, needs to be connected to the water source all the time during the use, which is seriously limited by the location of the water source and reduces its practicality.

Therefore, it is necessary to provide a structure that can be applied to steam cleaning machine to solve the above technical problems by controlling the amount of steam through PWM.

### INVENTION CONTENT

The invention provides a structure for applying to the steam cleaning machine and controlling the amount of steam by PWM, which solves the problem that it needs to be connected to the water source all the time and is limited by the location of the water source, thus reducing its practicality.

In order to solve the above technical problems, this invention provides a structure for applying on the steam cleaning machine and controlling the amount of steam by PWM, including:
The shell, wherein one side of the shell is fixedly installed with a power line, the output end of the power line is electrically connected to the power switch, the output end of the power switch is electrically connected to the control board, and the output end of the control board is electrically connected to the water pump, steam generator and display screen;
The water tank, said water tank is fixedly installed at the bottom of the inner side of the housing, the bottom of the water tank is equipped with a drain cover, the top of the water tank is fixedly installed with an add water pipe, the top of the add water pipe extends to the top of the housing, the top of the add water pipe is fitted with a top cover, the input end of the pump is fixedly installed with a conveying pipe, one end of the conveying pipe is set on the inner side of the water tank, the output end of the pump is connected to the input end of the steam generator;
The steam pipe is set on the other side of the shell, and the output end of the steam pipe is fixedly installed with a steam nozzle.

Preferably, the outer side of the conveying pipe is provided with a support frame, and the bottom of the pump, the steam generator and the support frame are all fixedly installed at the top of the water tank.

Preferably, the power supply switch is fixedly installed on one side of the housing, the control board is fixedly installed on the inner side of the housing, and the display screen is fixedly installed on the front side of the housing.

Preferably, the bottom of the tank is fixed with a rubber pad around the four sides, and the front of the tank is set with a scale.

Preferably, the other side of the housing is fixedly installed with an insulation frame, the inner side of both ends of the insulation frame are rotably connected with a rotating pipe, the outer side of the rotating pipe is fixedly installed with a winding wheel, and the inner side of the side of the insulation frame is fixedly installed with a guide sleeve.

Preferably, one end of the rotating tube is fixedly installed with a rotating disk, the internal thread of the rotating disk is connected to a positioning screw, one end of the positioning screw is pressed against the end face of the insulation frame, and the other end of the rotating tube is rotatedly connected to the external output end of the steam generator.

Preferably, the other end of the steam pipe is fixedly installed on the outer side of the winding wheel, the inner side of the rotating pipe and the inner side of the steam pipe are connected, and the steam pipe is set on the inner side of the guide sleeve.

Compared with the related technology, the structure of the invention provided for application in the steam cleaning machine and controlled by PWM to control the amount of steam has the following beneficial effects:

This invention provides a structure for applying on a steam cleaner that controls the amount of steam through PWM by installing a water tank on the inner side of the casing and setting one end of the conveying pipe connected to the pump inlet on the inner side of the water tank. This way, during subsequent use, the water stored inside the water tank can be extracted and conveyed to the internal part of the steam generator for use. This makes the structure for applying on a steam cleaner that controls the amount of steam through PWM work without being continuously connected to the water source, thus not being restricted by the location of the water source, thereby enhancing the practicality of the structure for applying on a steam cleaner that controls the amount of steam through PWM.

### FIGURE DESCRIPTION

FIG. 1 is a schematic diagram of the first embodiment of the structure provided by the invention for applying to a steam cleaning machine and controlling the amount of steam through PWM;

FIG. 2 is another perspective structural diagram of the housing shown in FIG. 1;

FIG. 3 is another perspective structural diagram of the housing shown in FIG. 2;

FIG. 4 is a schematic diagram of the internal structure of the housing shown in FIG. 2;

FIG. 5 is a schematic diagram of a second embodiment of the structure provided by the invention for applying to a steam cleaning machine and controlling the amount of steam through PWM;

FIG. 6 is a schematic diagram of the top section structure of the insulation frame shown in FIG. 5.

Figure markings: 1. Enclosure, 11. Power Cable, 12. Power Switch, 13. Control Board, 14. Display Screen, 2. Pump, 21. Steam Generator, 22. Steam Pipe, 23. Steam Nozzle, 24. Conveying Pipe, 25. Support Frame, 3. Water Tank, 31. Ruler, 32. Gasket, 33. Drain Cover, 34. Water Supply Pipe, 35. Top Cover, 4. Insulation Frame, 41. Turning Tube, 42. Coiling Wheel, 43. Guide Sleeve, 44. Turning Disk, 45. Positioning Screw.

### SPECIFIC IMPLEMENTATION METHODS

The present invention is further described with reference to the drawings and embodiments.

### First Embodiment

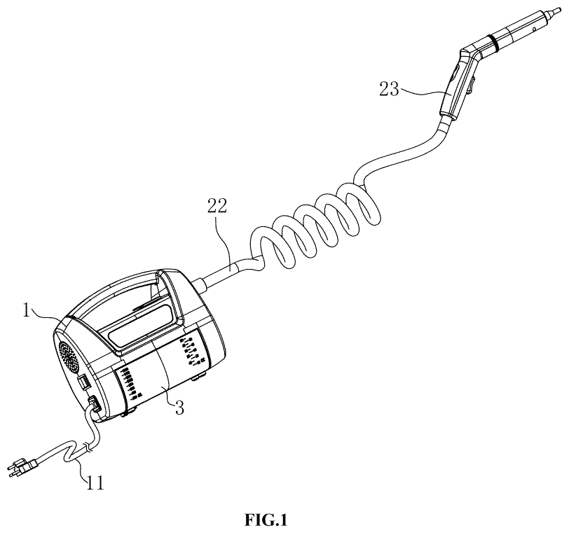

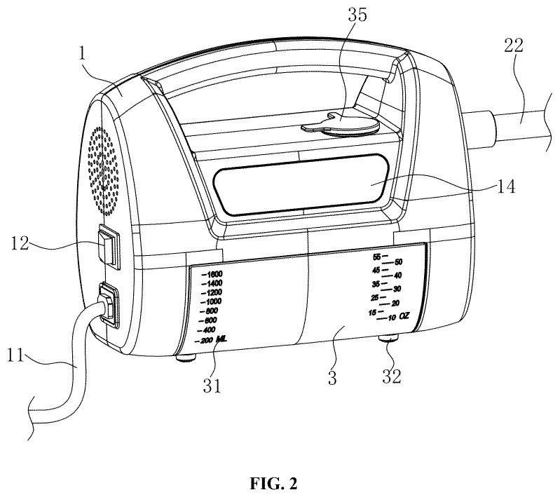

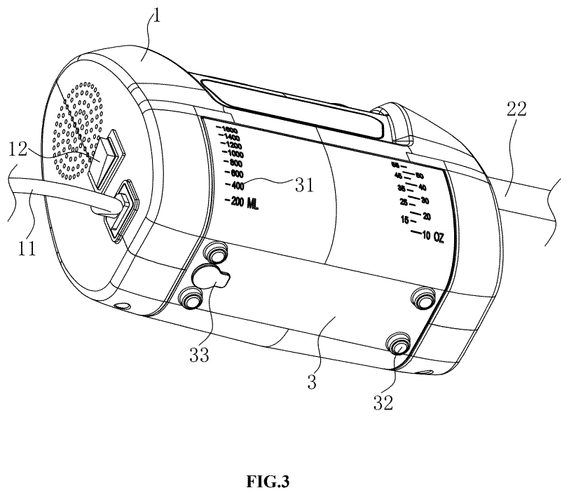

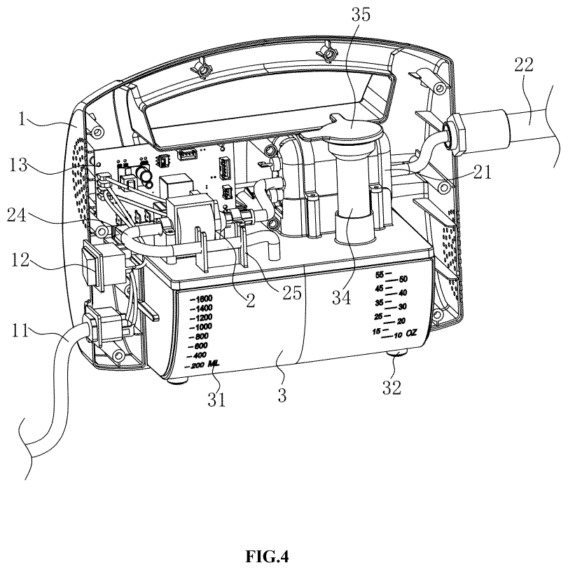

Please refer to FIGS. 1, 2, 3, and 4, where FIG. 1 is a schematic diagram of the structure of the first embodiment of an application for steam cleaning machines that controls steam volume through PWM; FIG. 2 is another perspective view of the housing shown in FIG. 1; FIG. 3 is another perspective view of the housing shown in FIG. 2; FIG. 4 is an internal structure diagram of the housing shown in FIG. 2.

A structure for applying to a steam cleaning machine and controlling the amount of steam by PWM includes: a housing 1, one side of which is fixedly installed with a power line 11, the output end of which is electrically connected to a power switch 12, the output end of which is electrically connected to a control board 13, and the output end of which is electrically connected to a pump 2, a steam generator 21, and a display screen 14;

Tank 3, said tank 3 is fixedly installed at the bottom of the inner side of the housing 1, a drain cover 33 is set at the bottom of tank 3, a water supply pipe 34 is fixedly installed at the top of tank 3, the top of the water supply pipe 34 extends to the top of the housing 1, the top of the water supply pipe 34 is equipped with a top cover 35, the input end of pump 2 is fixedly installed on the conveying pipe 24, one end of the conveying pipe 24 is set on the inner side of tank 3, the output end of pump 2 is connected to the input end of steam generator 21;

The steam pipe 22 is set on the other side of the housing 1, and the output end of the steam pipe 22 is fixedly installed with the steam nozzle 23.

The input end of the steam pipe 22 is connected to the output end of the steam generator 21, so that the steam generated by the steam generator 21 can be discharged through the steam nozzle 23;

Pump 2 determines the flow rate of water by detecting the neutral wire (which forms a square wave pattern that is received by control board 13) and then outputs a PWM signal from control board 13 to control the output power of the optocoupler and thyristor, thereby achieving the flow rate of water by Pump 2, and controlling the atomization size through steam generator 21; the PWM signal output by control board 13 can control the conduction time and frequency of the optocoupler, thus achieving the control of the timing and frequency of the thyristor.

The control board 13 is provided with a voltage reduction module, a light coupling and a thyristor;

The frequency of PWM refers to the number of times the signal goes from high to low and back to high per second, and the duty cycle is the ratio between the duration of the high level and the duration of the low level;

When the display screen 14 is used, it is used to display the operation of the steam generator 21 and the operation of the pump 2.

The outer side of the conveying pipe 24 is equipped with a support frame 25, and the bottom of the pump 2, the steam generator 21 and the support frame 25 are all fixedly installed at the top of the water tank 3.

The power switch 12 is fixedly installed on one side of the housing 1, the control board 13 is fixedly installed on the inner side of the housing 1, and the display screen 14 is fixedly installed on the front side of the housing 1.

The bottom of the tank 3 is fixedly installed with a rubber pad 32 around the four sides, and a scale 31 is set on the front of the tank 3.

Tank 3 is supported by transparent material and a scale 31 is set on the front of tank 3 so that users can easily observe the water capacity inside tank 3.

The working principle of the structure of the invention which is applied to a steam cleaning machine and controls the amount of steam by PWM is as follows:

When in use, the user opens the top cover 35 and fills the water tank 3s inner side with water through the water supply pipe 34. During subsequent use, connect the power cord 11 to the socket, then turn on the power switch 12, which allows the pump 2 and steam generator 21 to operate. The pump 2 draws water from inside the water tank 3 through the delivery pipe 24, then delivers it to the steam generator 21s interior, where it generates steam. The steam is then conveyed through the steam pipe 22 to the steam nozzle 23s interior, where it is sprayed out. After use, the user can open the drain cover 33 to drain the water from inside the water tank 3.

Compared with the related technology, the structure of the invention provided for application in a steam cleaning machine and controlled by PWM to control the amount of steam has the following beneficial effects:

By installing the water tank 3 on the inner side of the outer shell 1 and setting one end of the conveying pipe 24, which is connected to the input end of the pump 2, on the inner side of the water tank 3, this allows for the subsequent use to draw out the water stored on the inner side of the water tank 3 and convey it to the interior of the steam generator 21 for use. This makes the structure of the application in steam cleaning machines, which controls steam volume through PWM, work without being continuously connected to a water source, thus not being restricted by the location of the water source, thereby enhancing the practicality of this structure when used in steam cleaning machines.

### Second Embodiment

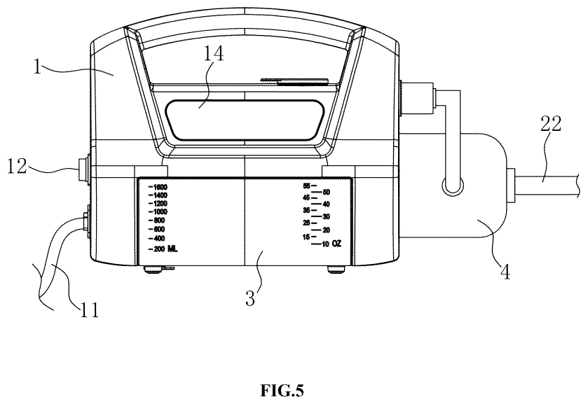

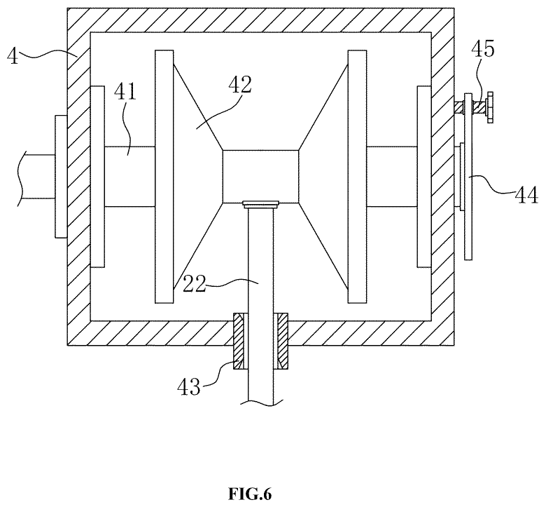

Please refer to FIGS. 5 and 6, the first embodiment of this application provides a structure for applying PWM control over steam volume in a steam cleaner, while the second embodiment proposes another structure for applying PWM control over steam volume in a steam cleaner. The second embodiment is merely an optional approach to the first embodiment, and the implementation of the second embodiment will not affect the separate implementation of the first embodiment.

Specifically, the second embodiment of this application provides a structure for controlling steam volume using PWM on a steam cleaner, where one such structure includes an outer shell 1 with an insulation frame 4 fixedly installed on one side, the insulation frame 4 has rotating tubes 41 at both ends that are rotably connected internally, the outer side of the rotating tubes 41 is fixedly installed with a winding wheel 42, and the inner side of the insulation frame 4 is fixedly installed with a guide sleeve 43.

One end of the rotating tube 41 is fixedly installed with a rotating disk 44, the internal thread of the rotating disk 44 is connected with a positioning screw 45, one end of the positioning screw 45 is pressed against the end face of the insulation frame 4, the other end of the rotating tube 41 is rotatedly connected to the external end of the output end of the steam generator 21.

The other end of the steam pipe 22 is fixedly installed on the outer side of the winding wheel 42, the inner side of the rotating pipe 41 is connected with the inner side of the steam pipe 22, and the steam pipe 22 is set on the inner side of the guide sleeve 43.

When in use, the user can determine the length of the steam pipe 22 according to the need, and take out the same length of the steam pipe 22 from the inner side of the insulation frame 4 for use, so that the excess steam pipe 22 continues to be wound on the outer side of the winding wheel 42;

The inner side of the insulation frame 4 is made of insulation cotton, and the outer side is a hard plastic shell. In this way, when used, it can keep the steam inside the steam pipe 22 that has not been extracted warm.

The working principle of a structure applied to a steam cleaning machine and controlled by PWM to control the amount of steam is as follows:

During use, the steam generated by the steam generator 21 enters the interior of the rotating tube 41 and is then conveyed to the interior of the steam pipe 22 through the rotating tube 41, subsequently being sprayed out through the steam nozzle 23. After use, the user can rotate the rotating disc 44, which drives the rotating tube 41 and the winding wheel 42 to rotate, thereby allowing the winding wheel 42 to wind up the steam pipe 22, thus repositioning the steam pipe 22. After winding is complete, the user rotates the positioning screw 45, which is threaded into the interior of the rotating disc 44, ensuring that one end of the positioning screw 45 contacts the side of the insulation frame 4, thereby limiting the rotation of the rotating tube 41 and the winding wheel 42.

Compared with the related technology, the structure of the invention provided for application in the steam cleaner by PWM control of steam quantity has the following beneficial effects:

Through the cooperation of the insulation frame 4, rotating tube 41, winding wheel 42, rotating disk 44 and positioning screw 45, when in use, the steam pipe 22 can be wound on the outer side of the winding wheel 42, so as to facilitate the users storage of the steam pipe 22.

The above-described is merely an embodiment of the invention and does not limit the patent scope of the invention in any way. Any equivalent structural or equivalent process transformation made by utilizing the contents of the specification and drawings of the invention, or directly or indirectly applied to other related technical fields, are equally included within the scope of patent protection of the invention.

1. A structure for applying to a steam cleaning machine and controlling the amount of steam by PWM, characterized in that it includes:
The shell, wherein one side of the shell is fixedly installed with a power line, the output end of the power line is electrically connected to a power switch, the output end of the power switch is electrically connected to a control board, and the output end of the control board is electrically connected to a water pump, a steam generator and a display screen;
The water tank, said water tank is fixedly installed at the bottom of the inner side of the housing, the bottom of the water tank is equipped with a drain cover, the top of the water tank is fixedly installed with an add water pipe, the top of the add water pipe extends to the top of the housing, the top of the add water pipe is fitted with a top cover, the input end of the pump is fixedly installed with a conveying pipe, one end of the conveying pipe is set on the inner side of the water tank, the output end of the pump is connected to the input end of the steam generator;
The steam pipe is set on the other side of the shell, and the output end of the steam pipe is fixedly installed with a steam nozzle.

2. A structure for applying on a steam cleaning machine according to claim 1, characterized in that, the outer side of the conveying pipe is equipped with a support frame, and the bottom of the pump, the steam generator and the support frame are all fixedly installed at the top of the water tank.

3. A structure for applying to a steam cleaning machine according to claim 1, characterized in that the power switch is fixedly installed on one side of the housing, the control board is fixedly installed on the inner side of the housing, and the display screen is fixedly installed on the front side of the housing.

4. A structure for applying to a steam cleaning machine and controlling the amount of steam by PWM, according to claim 1, characterized in that a rubber pad is fixedly installed around the bottom of the water tank and a scale is set on the front of the water tank.

5. A structure for applying on a steam cleaning machine according to claim 1, characterized in that the other side of the housing is fixedly installed with an insulation frame, the inner sides of both ends of the insulation frame are rotably connected with rotating tubes, the outer side of the rotating tube is fixedly installed with a winding wheel, and the inner side of the side of the insulation frame is fixedly installed with a guide sleeve.

6. A structure for applying on a steam cleaner according to claim 5, characterized in that the rotating tube is fixedly installed at one end with a rotating disk, the internal threads of the rotating disk are connected to positioning screws, one end of the positioning screws contacts the end face of the insulation frame, and the other end of the rotating tube is rotatively connected to the external output end of the steam generator.

7. A structure for applying on a steam cleaning machine according to claim 6, characterized in that the other end of the steam pipe is fixedly installed on the outer side of the winding wheel, the inner side of the rotating pipe is connected to the inner side of the steam pipe, and the steam pipe is set on the inner side of the guide sleeve.
